(19) United States
(12) Patent Application Publication
(10) Pub. No.: US 2002/0031098 A1
(43) Pub. Date: Mar. 14, 2002

(54) METHOD OF BI-DIRECTIONAL DATA TRANSMISSION OVER A TWO-WIRE LINE

(76) Inventor: JOHANN PFEIFFER, ALLENTSTEIG (AT)

Correspondence Address: BURNS DOANE SWECKER & MATHIS L L P, POST OFFICE BOX 1404, ALEXANDRIA, VA, 22313-1404, US

(21) Appl. No.: 08/981,519

(22) PCT Filed: Jun. 21, 1996
(86) PCT No.: PCT/AT96/00112

(30) Foreign Application Priority Data
Jun. 26, 1995 (AT) A 1087/95

(51) Int. Cl. H04B 1/44; H04L 12/28

(52) U.S. Cl. 370/282; 370/351

(57) ABSTRACT

Proposed is a method of bidirectional data transmission over a twowire line. Digital data destined for transmission or reception, e.g. using discrete multitone modulation (DMT), are modulated or demodulated as appropriate and separated by timedivision multiplexing. The appropriate multiplex time frame is subdivided into a predetermined number N of time slots and a number K of those time slots is assigned exclusively to one direction, e.g. transmission, the remaining time slots (=NK in number) being assigned exclusively to the other direction (e.g. reception).

The invention relates to a method for bidirectional data transmission via a two-wire line, digital data being modulated or demodulated for transmission or reception, for example by means of discrete multitone modulation (DMT), and the data to be transmitted and the data to be received being separated, for example by frequency division multiplex operation (FDM) or echo cancelling (EC).

In order to eliminate interfering influences of data to be communicated, known methods of this type carry out separation of the e.g. DMT-modulated data in frequency division multiplex operation (FDM), different frequency ranges being defined for the two transmission directions. Another possible separation option consists in the application of the echo cancelling method (EC), in which, by using adaptive filters, the influence of the transmission section on the receiver is suppressed by adaptive filters. Other separation methods have not been used to date in this connection in the prior art.

During transmission, the FDM method generates a lower and an upper frequency band corresponding to the two transmission directions. However, since the cable attenuation is dependent on frequency, major difficulties arise in obtaining the same transmission quality for both transmission channels; in the majority of cases, the transmission quality is better in one direction than in the other. In general, however, it is desirable to be able to offer quality that is as far as possible identical for both channels. Furthermore, in FDM the variation of the transmission capacity is associated with considerable effort, since it requires matching of the bandpass filters used in each case, so that the channel bandwidth can be correspondingly increased or reduced.

The echo cancelling method that is disclosed, furthermore, in the prior art also has disadvantages, although of a different nature. Thus, near-end crosstalk is a major technical problem in this method, since the signal distance between transmitted and received signal is very large. It is therefore necessary to satisfy very high requirements made of the A/D converters provided in the transmission and reception sections, since transmitted and received signals occur simultaneously and they must be appropriately well separated. The high level differences of the transmitted and received signals require a correspondingly high resolution of the A/D converters, which, in turn, results in higher product costs.

The implementation of these known separation methods FDM and echo cancelling also requires a relatively high computer power, which greatly increase [sic] the costs for the data transmission. Particularly when being employed in cases where, such as in the case of ADSL (Asymmetric Digital Subscriber Line), for instance, high data rates are to be communicated in one transmission direction (“downstream”) from a central data station to a subscriber located as part of the peripheral equipment and comparatively low data rates are to be communicated in the other transmission direction (“upstream”), the complexity created in these known data transmission methods is subject to poor utilization.

The aim of the invention is to specify a method which is distinguished by a low degree of complexity with regard to hardware use or computer power, so that it can be implemented in a simple and cost-effective manner.

Furthermore, the aim of the invention is to provide a method which enables transmissions which proceed to a great extent only in one of the two transmission directions to be carried out at a high transmission rate.

A further object of the invention is to achieve a very good transmission quality with relatively little technical outlay, the intention being that a change in the transmission capacity will be possible in a simple and cost-effective manner.

According to the invention, this is achieved by virtue of the fact that the data to be transmitted and the data to be received are separated by time division multiplex operation (TDM), the associated multiplex time frame being subdivided into a predeterminable number N of time slots, and of these a number K of time slots being assigned exclusively to one transmission direction, for example transmit, and the remaining number (N−K) of time slots being assigned exclusively to the other transmission direction, for example receive.

Since either only transmitter functions or only receiver functions are active in the method according to the invention, less processor power than in conventional methods is required, since the latter have to manage a very high internal data traffic. As a result, it is possible for a transmission which is carried out by the method according to the invention to be implemented in a very cost-effective manner.

Furthermore, the method according to the invention affords the advantage of an identical transmission quality in both transmission directions, since transmission and reception take place with the same line attenuation in TDM. As a result, both transmission directions can be implemented with the least possible quality reduction in the same frequency range. A further advantage of the method according to the invention is the very simple changing of the transmission capacity, which is enabled by corresponding selection of the number of time slots for the respective transmission direction.

In the event of asymmetric data transmission, it may be particularly advantageous if the vast majority of the data is transmitted in one transmission direction and only a small remainder is transmitted in the other transmission direction. This is provided when the number N of time slots is selected to be very much greater than the number K. This condition is preferably fulfilled when N is equal to 30 and K is equal to 1.

Since the method according to the invention can be employed for data transmission via telephone lines, pulse-like interference may occur on the line as a result of the number dialling, for example, the interference effecting a transmission error which absolutely must be corrected. However, the data transmission does not have to be carried out via telephone lines; within the scope of the invention, the data transmission can take place via any two-wire line suitable for this purpose. Equally, extremely varied electromagnetic interference, even such that is external to the system, may influence the data transmission.

The known ARQ (Automatic Repeat Request) method is usually employed for the purpose of error correction in such a way that the data transmission remains free from errors even in the event of arbitrary interference on the line, in which case, however, the data through-put may decrease considerably since an erroneously transmitted data packet is repeated until it is received without any errors.

In a further design of the invention, therefore, it may be provided that a predeterminable number of time slots for ARQ (Automatic Repeat Request) transmission repeats are provided on average over time in the multiplex time frame of the data transmission.

Consequently, transmission overcapacity is constantly available in this embodiment. If a data block is received with errors, the receiver requests a repeat only as often as is possible within the scope of the overcapacity which is available on average over time, thereby enabling the nominal data throughput to be kept constant in a manner such that it is unaffected by the transmission repeats. A signal containing relatively high redundancy is communicated in the event of error-free transmission. The duration of the time interval over which the time averaging takes place is essentially limited by the storage capacity of the ARQ buffer used.

According to another variant of the invention, it may be provided that in the event of erroneous transmission, the data are retransmitted after having been modified, for example by means of a computing algorithm.

This makes it possible to correct the error which occurs during transmission and is caused by the clipping of part of the amplitude in the event of transmission overmodulation.

In a particularly preferred manner, it may be provided in this case that the data are modified by logic inversion.

This inversion operation represents an algorithm which can be calculated very simply and can be realized without a high degree of complexity.

Furthermore, it may be provided that the switching frequency of an interference source, for example a power supply unit, is synchronized with one of the carrier frequencies of the discrete multitone modulation.

As a result, the DMT method, which is sensitive to frequency-selective interference, can be protected against known interference sources. When the switching frequency of the interference source is synchronized with one of the carrier frequencies of the DMT modulation, the interference acts only on this carrier frequency and multiples thereof, with the result that they can be compensated for by an adaptive algorithm.

Crosstalk, which, by its nature, has an interfering effect on the transmission, is usually produced when a plurality of two-wire lines, on each of which data are transmitted, are routed next to one another.

According to another embodiment of the method according to the invention, in which data are transmitted via two or more two-wire lines which are routed at least partially at crosstalk distance, it may be provided that the time division multiplex operation (TDM) is carried out synchronously on all of the two-wire lines, with the result that either transmission or reception is performed simultaneously on all of the two-wire lines.

As a result, either transmission or reception is always performed at the same time, thereby making it possible to prevent the individual receivers from being influenced in an interfering manner by transmitters that are not directly connected.

The invention is explained in more detail below using an exemplary embodiment which is illustrated in the drawings.

In the figures:

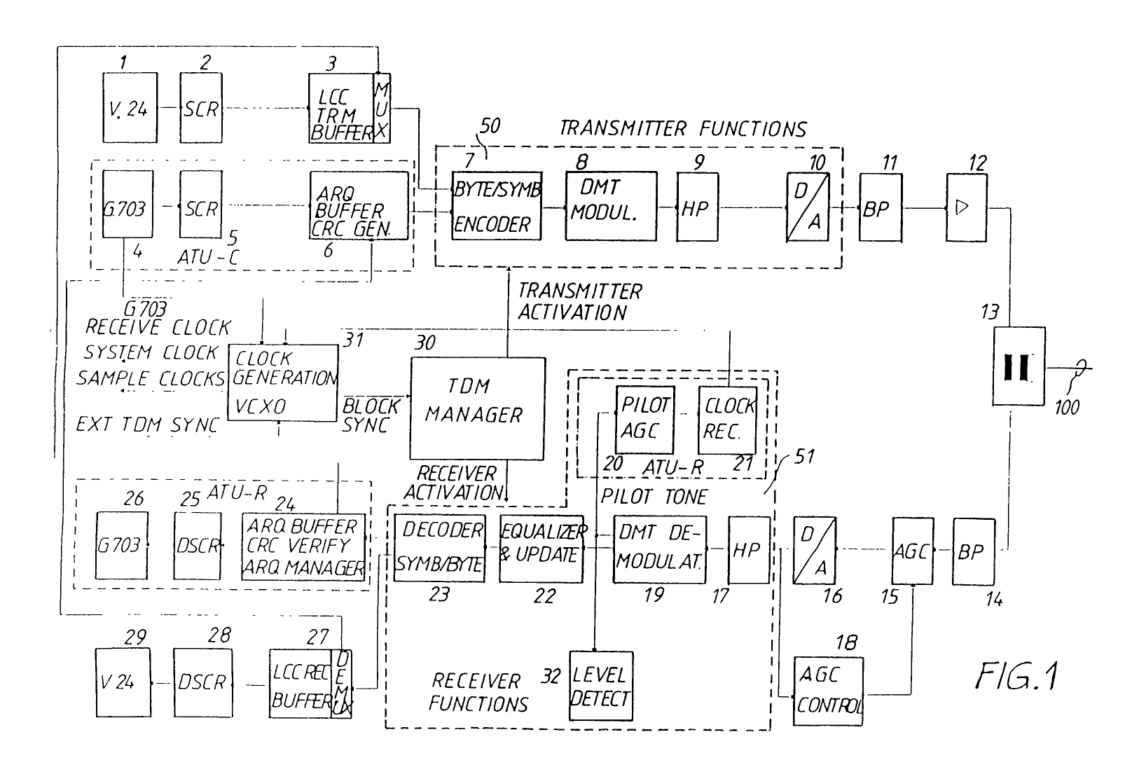

FIG. 1 shows a block diagram for the implementation of one embodiment of the method according to the invention, and

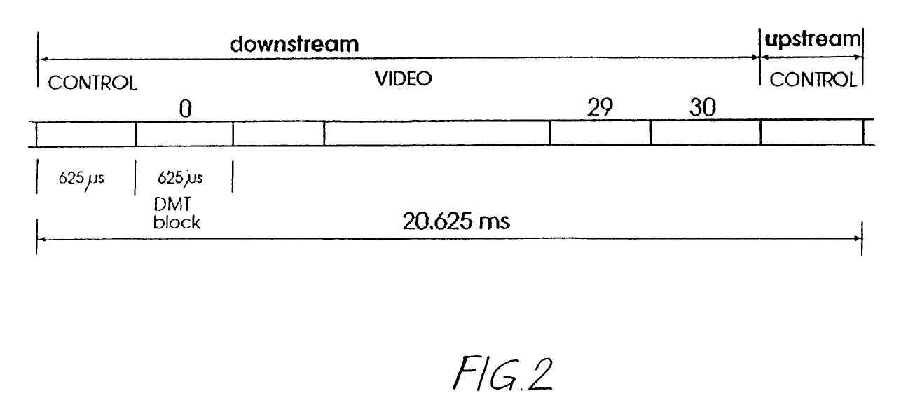

FIG. 2 shows a diagrammatic illustration of a time frame according to the invention.

Bidirectional data transmission of digital data in accordance with the block diagram illustrated in FIG. 1 is carried out in that, in the event of transmission, the digital data coming from a data source 1, 4 are converted into an analog transmission signal in the transmission section 50 and are transmitted via a line transformer 13 of a two-wire line 100 to a subscriber located at the end of this line 100. By contrast, a signal arriving on the two-wire line 100 is passed as received signal via the line transformer 13 to the input of a reception section 51, where it is converted into digital data. Since transmission and reception are never performed simultaneously in the method according to the invention, the line transformer 13 can be used instead of a hybrid that is otherwise customary, as a result of which the often problematic matching of the hybrid to the line impedance is obviated from the outset. Interfering crosstalk which is caused by a hybrid and as a result of which signal residues pass from the transmitter to the receiver of the same subscriber end is consequently precluded as an interference source for this method.

In the exemplary embodiment shown in FIG. 1, the transmission and reception sections 50, 51 both of a central data station C (CENTRAL) and of a peripheral data station R (REMOTE) are illustrated in a single block diagram, which should be understood such that the central data station C is connected to the data station R via the transformer 13, the two-wire line 100 and a further transformer 13. Those functional units which are associated only with the data station C or R are identified by “ATU-C only” or “ATU-R only”.

Without restricting the general applicability of the method according to the invention, a home video system will be described as an exemplary embodiment of asymmetric data transmission, in which system the video information of different videos are stored as data in compressed form in a mainframe in the central data station C and can be called up via a peripheral data station R. The control information is exchanged between the data stations C and R via a bidirectional control channel, a data rate of 64 kbit/s being stipulated. This control information may refer to various commands to be issued by the subscriber, such as, for instance, PLAY, REWIND or the like, as are known by a video recorder, as well as internal control commands, and is comparatively modest in terms of its quantity compared with the broadband information which is sent from the central data station C and essentially comprises the video information which is transmitted at a data transmission rate of 2.048 Mbit/s only in one direction from C to R.

However, the data rates cited may alternatively be selected such that they are completely different, for example a great deal higher, for the method according to the invention, in which case even a data rate of about 50 Mbit/s to 150 Mbit/s can be made available for the broadband information to be communicated only in one direction. The transmitted information can constitute every type of voice, image or data information. Equally, a different rate can be implemented for the bidirectional control channel, which, however, can fulfil not only control functions but all of the possible data transmission functions.

At the input part of the transmission section 50, two different data inputs are constructed for the data station C and only one data input for the data station R. The data stream from the data source 1 passes to the first input, which is identical for C and R, the data source transmitting e.g. essentially control commands which pass via a downstream scrambler 2 into a transmission buffer 3 downstream of the latter, the data coming from the data source 1 being converted according to a predeterminable algorithm in the scrambler 2. This prevents a relatively lengthy, constant logic state and achieves balanced, random distribution of the binary states. Afterwards, the scrambled signals are buffer-stored in the transmission buffer 3. In the data station R, the data issuing from the transmission buffer 3 are multiplexed by means of a device MUX with other data, which are generated in the ARQ buffer 24 and contain repeat instructions.

The data stream from the data source 4, which generates the broadband information, reaches the second input of the transmission section 50, which is designed only for the data station C, the data stream reaching the second input of the transmission section 50 via a downstream scrambler 5 and via an ARQ (Automatic Request) buffer 6, which contains a CRC generator by means of which error correction coding is carried out. The data converted in the scrambler 5 are buffer-stored in the ARQ buffer 6 and repeated in the event of erroneous transmission. A special ARQ transmission technique according to the invention will be described below.

The data arriving serially via the inputs of the transmission section 50 are combined in a predeterminable length in the encoder 7 in order to reduce the data rate and, using an encoding table, are assigned to a corresponding symbol for the purpose of further processing. Furthermore, this encoded signal is modulated in the downstream DMT (Discrete Multi Tone) modulator 8 according to this known method and is passed via a high-pass filter 9, which essentially suppresses the voice frequency band in order to avoid interfering influences. The digital output signal of this high-pass filter 9 is converted into an analog signal by means of a digital-to-analog converter 10, which analog signal passes via a bandpass filter 11 and then via an amplifier 12 to the transformer 13. On the one hand, the bandpass filter 11 again performs the function of the high-pass filter 11 [sic] and, on the other hand, it clips the high-frequency voltage spikes caused by the analog-to-digital [sic] converter 10. The frequency of the analog-to-digital [sic] conversion is selected to satisfy the sampling theorem such that sampling by the analog-to-digital [sic] converter 10 is effected at least twice for the highest frequencies that occur.

The transmission section 50 and the reception section 51 are controlled by a TDM (Time Division Multiplex) unit 30, with the result that, according to the invention, the data to be transmitted and the data to be received are separated by time division multiplex operation, the associated multiplex time frame being subdivided into a predeterminable number N of time slots, and of these a number K of time slots of the time frame being assigned exclusively to one transmission direction, for example transmit, whereas the remaining number N−K of time slots being assigned exclusively to the other transmission direction, for example receive. For this purpose, the TDM unit controls the transmission section 50 and the reception section 51 by activating them at the given time. In this case, the transmission section 50 and the reception section 51 are never in operation at the same time, as a result of which the processor power required for the control can be designed to be correspondingly low. Since influencing of the receiver by its own transmitter is also precluded as a result, only a low resolution is necessary for the analog-to-digital converter 16 of the receiver section. This advantage is highly cost-effective on account of the direct proportionality of resolution and price in the case of analog-to-digital converters.

The method according to the invention has the advantage of a relatively low bandwidth requirement and a very low degree of complexity, which is reflected in the hardware and in the requisite computer power. In conventional methods for separating transmission and reception, a considerable part of the computer power is lost on internal communication, whereas in the method according to the invention, this auxiliary computer capacity can be kept very low.

The limit of the method according to the invention is where the proportion of transmission and reception approaches the 50% limit, since other methods such as echo cancelling or the like can then be implemented with the same or less complexity.

FIG. 2 illustrates the time frame subdivided into time slots which is of the kind used in the method according to the invention. The two transmission directions are identified by the expressions “upstream” and “downstream”. In this example, the total time frame is 20.625 ms long and is subdivided into various slots of 625 μs, the majority of the data being transmitted in the downstream direction. This division is particularly advantageous when a bidirectional channel having a low data rate and a unidirectional channel having a high data rate are required in one transmission direction. In the exemplary embodiment illustrated, control commands are transmitted via the bidirectional channel by the time slots designated by CONTROL in the downstream and upstream directions and video information is transmitted via the unidirectional channel by the 30 downstream time slots designated by VIDEO together with one auxiliary slot on average over time. This type of transmission can be effected for any desired information items.

The distribution of the transmission and/or reception capacities can be adapted to the respective conditions by selection of the number of upstream and/or downstream time slots. In the event of changes in the capacity utilization, this ratio can be matched automatically in accordance with the current requirement. The defined transmission and reception times have the advantage over frequency division multiplex transmission that data to be received and data to be transmitted do not have to be processed simultaneously, as a result of which the computer power or the hardware outlay can be designed to be correspondingly low. One encoded and DMT-modulated data unit is transmitted in each DMT slot.

For ARQ transmission repeats, a predeterminable number of time slots for ARQ transmission repeats are provided on average over time in the multiplex time frame of the data transmission according to one embodiment according to the invention. For this purpose, when the data are transmitted, they are continually written to the ARQ transmission buffer 6 and forwarded again from the latter to the encoder 7. In this case, the data leaving the buffer 6 are transmitted more rapidly than said buffer is filled. The last data block is in each case entered anew into the resulting gap, said data block, however, being identified as a repeated block at the receiver end and being automatically eliminated. Consequently, in the event of error-free transmission, transmission is constantly performed with overcapacity, without the transmitted information content being greater.

As soon as a transmission error occurs, the receiver in the peripheral data station R detects the error by means of its CRC error detection in the ARQ unit 24 and then forwards the command for data repetition via the multiplexer of the transmission buffer 3, which command is then transmitted as control information via the bidirectional channel. In the central data station C, this information is demultiplexed in the receiver buffer 27 after passing through the receiver section 51, and a control command to repeat the erroneous transmission is passed to the ARQ buffer 6.

In this exemplary embodiment, only one auxiliary slot is available, on average over time, for this purpose, which corresponds to an overcapacity of 3.33%. The duration and number of the auxiliary slots are not subject to any restriction in this connection and can be adapted to the respective conditions as desired within the bands of what is technically feasible.

After an erroneous transmission, the repeat transmission is then carried out in the subsequent time frame, which repeat transmission may extend over a plurality of successive time slots. Averaged over time, only one time slot per frame should be used for the repeats in this example.

The time interval over which the time average is calculated is defined by the size of the ARQ buffer store. As soon as the latter is filled to capacity with information, no further repeats can be carried out and the erroneous data block must be output as transparent.

In contrast to a conventional ARQ method, the time interval which is defined for the data repeats is fixed on average over time. As a result, it is not possible for the situation to arise where, on account of a relatively lengthy interference, the transmission is repeated until it is free from errors and, as a result, the transmission time is greatly increased. The known ARQ method causes the data transmission to be repeated even in the event of arbitrary interference until it is received without any errors, as a result of which, however, the data throughput decreases to a very great extent. In contrast, the fixed overcapacity lying between 2 and 10%, but preferably between 3 and 5%, in the method according to the invention causes the transmission to be repeated only as often as is possible within the scope of the overcapacity, in order to maintain the nominal data throughput. If one of a plurality of successive incorrect data blocks can no longer be repeated and received correctly, it is output as transparent.

In the case of a signal which is modulated by discrete multitone modulation (DMT), the ratio of peak value to average value is very large, with the result that clipping of the signal peak represents a frequent error source. In order to correct this error in a simple manner, after erroneous data transmission, the digital bit train can be modified during the repeat operation in the transmitter, for example by a computing algorithm, and then retransmitted. In the receiver, the computing algorithm used is correspondingly applied inversely and the data are recovered. As a result, this transmission error can be eliminated very effectively. In particular, transmission of the erroneous data in inverted form can be implemented in a simple manner in terms of circuitry or computation.

A further interference source in the DMT method results from the switching frequency of the voltage supply used, for example of the power supply unit, since this switching frequency lies in the transmission range and, consequently, manifests its effect as frequency-selective interference. Added to this is the dependence of this interference on other influencing variables, for instance the load currently present on the power supply unit. This type of interference can be reduced by synchronizing the switching frequency of the power supply unit with one of the carrier frequencies of the DMT modulation. As a result, this interference acts only on this carrier frequency and its multiples, with the result that they can be compensated for very easily by an adaptive algorithm.

FIG. 1 furthermore illustrates the reception section 51 corresponding to the transmission section 50. The signals arriving from the other subscriber end via the two-wire line 100 and the transformer 13 are passed via a bandpass filter 14 and via an AGC (Automatic Gain Control) unit, which generates a signal of approximately constant amplitude irrespective of the instantaneous signal conditions on the line, to the input of an analog-to-digital converter 16 which is associated with the reception section 51 and whose output is connected to a high-pass filter 17. The signal present at the input of the high-pass filter 17 is fed back as manipulated variable to the AGC unit 15 via an AGC control circuit 18.

The high-pass filter 17 is followed by demodulation of the signal, from which, only in the peripheral data station R, the concomitantly transmitted pilot tone is fed to a pilot AGC unit 20, from which a reference signal for the clock generation unit 31 of the peripheral data station R is obtained in the clock recovery unit 31. This clock generation unit 31 generates the time base for the TDM unit 30 and for the system clock. The data station C does not require a clock recovery unit since an independent time base is provided there.

The linear distortion effected by the transmission path is eliminated in an equalizer 22 which follows the DMT demodulator 19 and has an update function. Afterwards, decoding in accordance with a decoding table takes place in a decoder 23, whereupon a serial bit stream is again present at the output of the decoder 23, which bit stream is passed via two outputs. The first output, which is constructed identically for data station C and R, comprises a reception buffer 27 for control information, a downstream descrambler 28, in which the data are re-established in their correct order, and the data sink 29, which receives the transmitted control data. The second output of the reception section 51, which is provided only for the data station R, is connected to an ARQ buffer 24, which buffer-stores and verifies the transmitted broadband information from the data station C and, if required, passes the command for renewed transmission of the erroneously transmitted data via a control unit integrated in the ARQ buffer 24 to the multiplex input of the transmission buffer 3, which command is transmitted back to the data station C. Connected to the output of the ARQ buffer 24 is a descrambler 25 and, following the latter, a data sink 26 for accepting the broadband information.

If data are transmitted via two or more two-wire lines which are routed at least partially at crosstalk distance, it can happen that crosstalk occurs as a result of the mutual inductive influence of the two-wire lines. This undesirable interference may occur particularly in a central data station in which a large number of outgoing two-wire lines are routed next to one another.

In one embodiment of the method according to the invention, this type of interference is avoided by carrying out the time division multiplex operation synchronously on all of the two-wire lines. This means that either transmission or reception is performed simultaneously via all of the two-wire lines, with the result that influencing is not possible.

1. A method for bidirectional data transmission via a two-wire line, digital data being modulated or demodulated for transmission or reception, for example by means of discrete multitone modulation (DMT), and the data to be transmitted and the data to be received being separated, for example by frequency division multiplex operation (FDM) or echo cancelling (EC), wherein the data to be transmitted and the data to be received are separated by time division multiplex operation (TDM), the associated multiplex time frame being subdivided into a predeterminable number N of time slots, and of these a number K of time slots being assigned exclusively to one transmission direction, for example transmit, and the remaining number (N−K) of time slots being assigned exclusively to the other transmission direction, for example receive.

2. The method as claimed in claim 1, wherein N is equal to 30 and K is equal to 1.

3. The method as claimed in claim 1 or 2, wherein a predeterminable number of time slots for ARQ (Automatic Repeat Request) transmission repeats are provided on average over time in the multiplex time frame of the data transmission.

4. The method as claimed in claim 1, 2 or 3, wherein in the event of erroneous transmission, the data are retransmitted after having been modified, for example by means of a computing algorithm.

5. The method as claimed in claim 4, wherein the data are modified by logic inversion.

6. The method as claimed in claims 1 to 5, wherein the switching frequency of an interference source, for example a power supply unit, is synchronized with one of the carrier frequencies of the discrete multitone modulation.

7. The method as claimed in claims 1 to 6, data being transmitted via two or more two-wire lines which are routed at least partially at crosstalk distance, wherein the time division multiplex operation (TDM) is carried out synchronously on all of the two-wire lines, with the result that either transmission or reception is performed simultaneously on all of the two-wire lines.
